(19) United States
(12) Patent Application Publication
(10) Pub. No.: US 2012/0078534 A1
(43) Pub. Date: Mar. 29, 2012

(54) Use of Optical Fiber for Distributed Monitoring of Machinery

(76) Inventors: John S. Selker, Corvallis, OR (US); Frank Selker, Portland, OR (US)

(21) Appl. No.: 13/249,016

(22) Filed: Sep. 29, 2011

Related U.S. Application Data
(60) Provisional application No. 61/404,163, filed on Sep. 29, 2010.

(51) Int. Cl. G06F 15/00; G01K 11/32; G06F 17/18; G01H 9/00

(52) U.S. Cl. 702/33; 702/189; 702/134; 702/180

(57) ABSTRACT

A method and system using fiber optic sensors are provided for the distributed monitoring of the condition of machinery having multiple elements. A sensor including an optical fiber is mechanically coupled to, or in the proximity of, multiple elements of machinery in order to monitor vibration, temperature, and/or strain of such elements. Data are collected in a form suitable for storage, transmission, and analysis, and may be used to control alarms, machinery, or may be displayed to convey condition of machinery. One embodiment is the monitoring of elements of conveyor systems, such as rollers, bearings, idler wheels, power components, and the belt. The detection of condition and changes in condition, as well as the display of information, is enhanced by using information from a plurality of related or similar elements.

### CROSS REFERENCE TO RELATED APPLICATIONS

This application claims priority to U.S. Provisional Patent Application No. 61/404,163, filed Sep. 29, 2010, the entirety of which is hereby incorporated herein by reference.

### TECHNICAL FIELD

This disclosure is for an apparatus and method for monitoring the condition of multiple elements of a machine using an apparatus and methods incorporating optical fiber. The optical fiber provides both the primary sensory transducers and a means for transmitting information from distributed machinery components back to locations where the data may be processed and stored. Particular advantages and features pertain to machinery with many related or similar components, with conveyor systems being one example.

### BACKGROUND

Machinery with many elements or components, such as conveyor belts with many rollers, are used in many industries. When worn or in need of maintenance, machinery components and/or their supporting structures can experience changes in vibration (either within the human acoustic range or outside of that frequency range), changes in temperature, or strains on the components or their supports.

In many machines, components may be distributed over large distances or areas. For example, large conveyor systems used to move bulk materials, such as minerals or grain, may be many kilometers in length and utilize hundreds of supporting idler rollers, each with multiple bearings. These machines can operate in environments in which monitoring the many rollers may be difficult and the cost of component failure may be high. For example, an overheated roller bearing in a coal mine could be difficult to inspect and access, yet could also cause an explosion, fire, expensive down-time, damage other elements of the machinery (e.g., the belt), and pose risks to worker safety. There is substantial value in enhancing means for monitoring such machinery, but with existing systems it can be difficult and expensive to monitor many components over large distances.

It is well known that optical fibers can be used as transducers for detecting and measuring a variety of physical parameters, including temperature, strain, and mechanical vibration. This is accomplished by sending light down a fiber and analyzing the backscattered or transmitted light for characteristics affected by such parameters, including frequencies, amplitudes, (e.g., Stokes and anti-Stokes shifts of Raman and Brillouin scattering) and phase shifts. In some such devices, the fiber material is modified in sections to create a response signal (e.g., Bragg gratings), but in the preferred systems the response of an un-modified fiber itself provides the backscattered signal. Measuring the time between injecting light and the reception of the signal, and knowing the velocity of the light in the fiber, allows determining the location at which the parameter values are measured. Thus, by analyzing and timing light signals, it is possible to measure various physical parameters at many locations along an optical fiber. Such systems typically report parameters at spatial resolutions from about one tenth of a meter up to several meters for fiber that are from several meters to many kilometers in length.

It is also well known that changes in vibration (used here to include all frequencies, including sub-sonic, audible, and ultrasonic frequencies) can be used to provide early warning of changes in bearings and other machinery that may indicate loss of lubrication, over lubrication, contamination, damage or degradation, and other operational issues. Acoustic and ultrasonic detection systems for this kind of monitoring and testing are commercially available. Vibration frequencies from 20 kHz-50 kHz are commonly used to monitor bearings, but lower and higher frequencies have also usefully tracked equipment performance. For example, if a roller is turning at 120 rpm and has a flat spot, it may produce a 2 Hz signal of interest. Conversely, small defects on bearings can induce ultrasonic ringing in connected elements and supports of the machinery. Changes in temperature (e.g., overheating of bearings) and strain of components and supporting structures (e.g., high forces due to failed bearings) may also be used to detect operational issues and equipment problems.

Optical fibers sensors have previously been used to monitor machinery, but have not achieved the full potential benefits of monitoring many related elements of machinery over substantial distances. By comparing and combining collected data from multiple similar and/or related elements it is possible to better distinguish changes that are unique to particular elements (such as a bearing failure) from changes that affect many elements (such as a changed loading of a conveyor belt). This is a fundamentally different mode of analysis than would be possible with a few point sensors or if the monitoring process did not analyzed the data as proposed in the current invention: The current invention monitors many locations and the data is evaluated not only by the absolute magnitude of a locally detected metric, but also by characteristics compared across several up to thousands of similar components. This allows for discriminating between local problems versus globally changing situations (e.g., the machine “warming up,” the load changing, speed of operation changing).

Additionally, by monitoring many related elements and processing the data accordingly, changing operational characteristics may be monitored that are not related to failures but are of operational interest, such as monitoring the progress of a new loading along a conveyor system. Issues in components that span many elements of a machine, such as the belt on a conveyor, may also be detected, for example by detecting changes at each element as a belt defect passes by. These are examples of the current invention's value for enhancing the sensitivity, specificity, and value of operational information that may be gained from sensing and processing information for multiple related components with a distributed system.

### BRIEF DESCRIPTION OF THE DRAWINGS

FIG. 1 is an illustration of a fiber optic sensor monitoring many machine elements (rollers of a machine and utilizing commonality and differences of signals to detect problems, changes, and status.

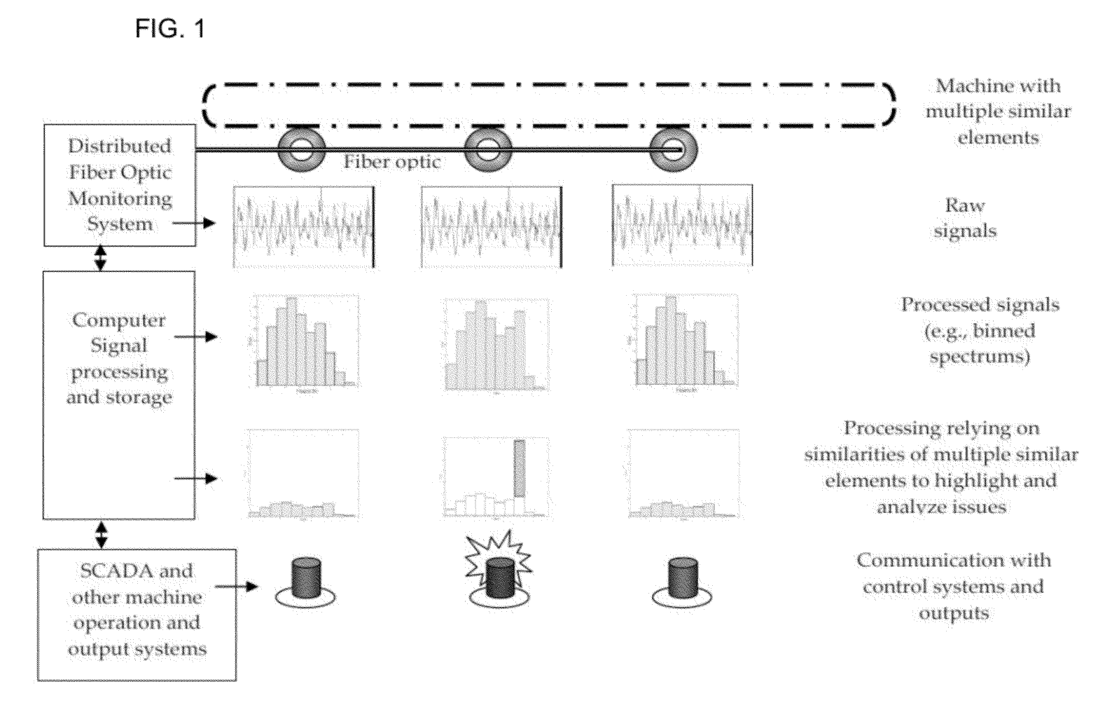

FIG. 2 is an embodiment of device using optical fiber to monitor condition of machinery, such as conveyor system, and to provide outputs including, for example, control signals, alarms, displays, and sounds.

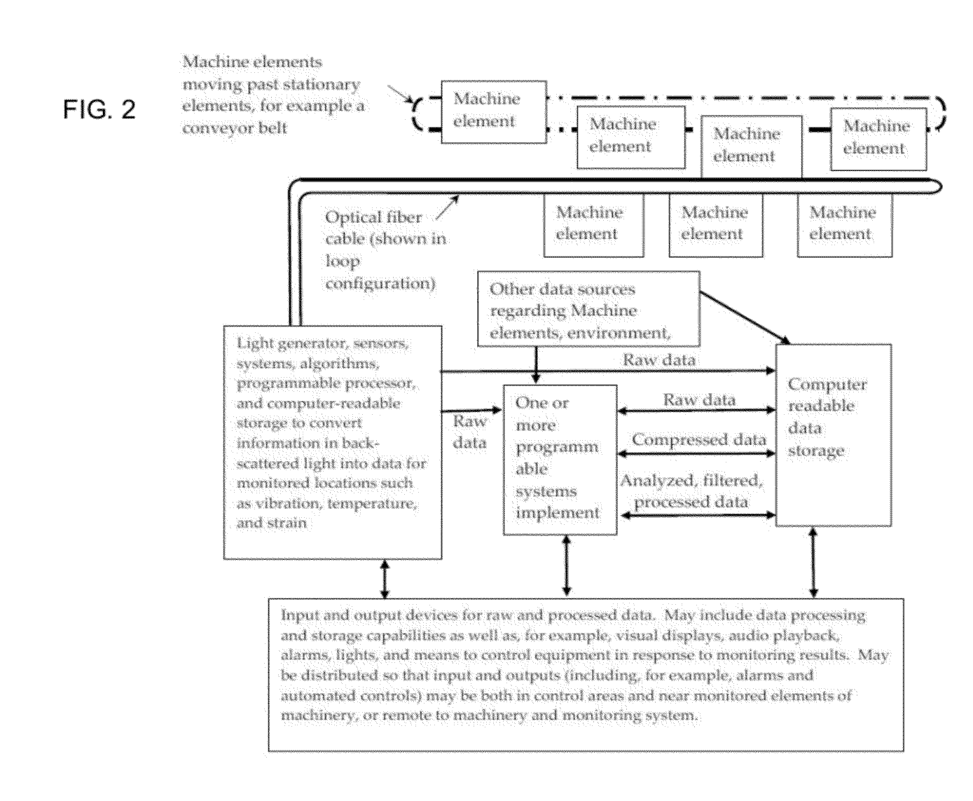

FIG. 3 is an embodiment of distributed monitoring system data collection, processing, storage, and input/output, showing adaptive filtering, compression, and data management.

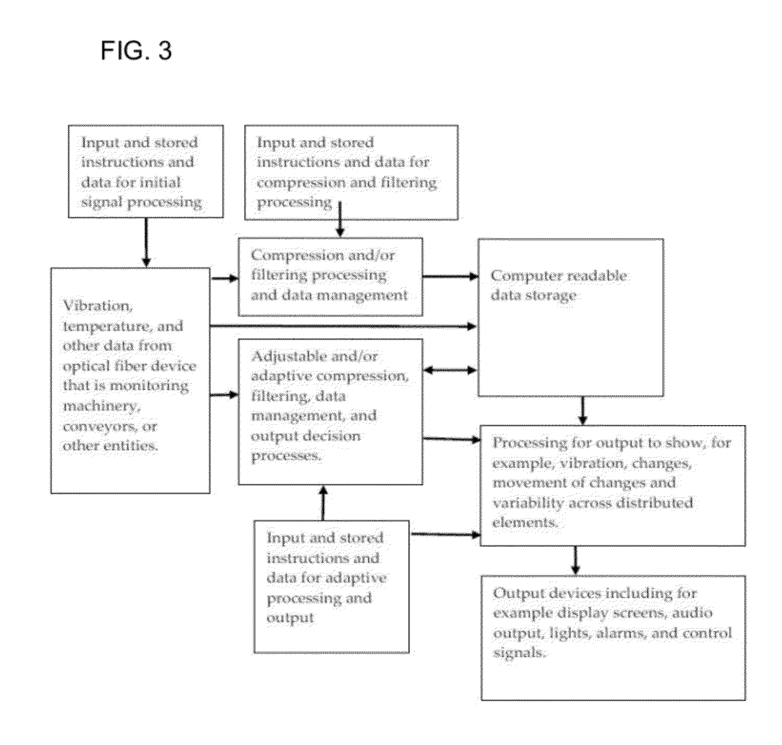

### DESCRIPTION OF INVENTION

The current invention pertains to the use of optical fibers to sense characteristics of multiple machine elements or components that may indicate wear, failure, a need for maintenance, operational state, or other states or actions. One or more optical fibers are built into cables that are coupled onto, or located near, machine elements or support structures for said elements, such that vibration, temperature, and/or strain changes associated with changes in the condition of the machine element will be detectible by the optical fiber cable. An instrument is attached to the optical fiber which injects light into the fiber, and processes light emerging from the fiber in order to generate data regarding parameters of interest along the fiber. This data is transmitted to one or more computers or other data processing device, with data and results of analysis being stored, transmitted, displayed, and used to support the optimal operation of the machinery being monitored. Analysis of the data includes known signal processing methods, but also uses the fact that multiple similar elements of the machine are being monitored, so that methods using comparisons and differences can reduce the rates of false negative and false positive outputs regarding changes in machine and machine element conditions across distance and through time.

The combination of monitoring many locations over substantial distances, which new fiber optic methods allow, and processing the data with the benefit of knowing that many monitored elements are similar, which relies on signal processing algorithms and modern high-capacity data processing and storage, allows a novel and valuable way to improve the ability to monitor large and complex machinery for changes or failure.

For example, processing may distinguish between characteristics of stationary components (e.g., idler rollers of a conveyor) and moving components that may pass near multiple sensors (e.g., conveyor belt). This may be accomplished by comparing and subtracting signals (either in the time or frequency domains) that are representative of normally operating repeated components from the component signals. When signals associated with normal operation are removed, changes and differences among elements will be evident. This facilitates detection of operational changes and defects that are passing along or through the machinery, and better identification and isolation of problems at particular locations.

The sensor cable may be mechanically coupled to elements of the conveyor belt machinery such as power components and idler roller components, or support structures for said components. The coupling of optical fiber cable to the machinery is implemented in a way that allows the cable to detect changes in parameters of the machine elements during operation that may indicate changed or deteriorated condition, and to provide information regarding the location of such detections. The coupling may be done to increase the length of fiber near a location by wrapping, looping, or spiraling cable on or near a component. The coupling of fiber and cable to machinery may be done with materials and methods that match impedance, thermal conduction, physical connection and/or otherwise enhance the signal amplitude and signal to noise ratio of collected data. In order to transmit a broad spectrum of vibration frequencies from machinery to the cable, a rigid attachment such as metal or hard polymer clamps will often be desirable.

Such coupling means may be selected to affect particular lengths of cable and may include solids, liquid, gel, gas, heat and vibration conducting materials, and a wide variety of adjustable hardware that may enhance the effectiveness of signal transmission and the practicality of the coupling. The couplings may also be designed to accomplish filtering, for example damping out certain frequencies of vibration that are not of interest. The attachments may also be implemented in a way that allows for convenient removal or replacement of the fiber. The coupling and cable supports may also incorporate elements intended to isolate sections of fiber from one another to minimize cross-talk among monitored locations. Examples include attaching heat sinks or mechanical damping or supports between locations of interest, with the goal of reducing the effect that signals at one location have on measurements at other locations.

The monitor system may include algorithms and methods to evaluate the condition of the machine elements based upon stored data, rules, and methods which include using information from multiple similar elements to enhance the sensitivity and reliability of findings. A wide variety of signal detection, filtering, pattern-recognition and enhancement, and processing means may be used to detect changes and conditions that are of interest. Examples include monitoring maximum amplitudes and power at various frequencies; monitoring amplitude or power excursions beyond certain threshold values or outside of trends; visualizing amplitude or power spectrums; neural networks or regression methods for detecting changes in signals that may indicate issues.

In the frequency domain it may be helpful to divide the spectrum into bins, with amplitude and power being monitored for each bin of the spectrum. Such binned signals may be compared across elements of the machine to identify locations in which certain frequencies are increasing or significantly larger than at other, similar elements. The rate of change and trends in changes may also indicate problems. For example with the power of the spectrum in a particular bin increasing beyond a usual rate of change could indicate a failing bearing. Methods may occur in the time or frequency domains, may involve amplitudes and phases, values and rates of changes in values, thresholds, adaptive algorithms, and other methods known to those skilled in the arts of signal processing.

Because the data is of high volume, the processing will include methods for handling such data streams that are known to those skilled in the arts. For example, it may incorporate data compression, filtering, frequency domain methods, and windowing in order to limit storage and display requirements while retaining and displaying useful information. Methods to be used will come from multiple disciplines, including optical signal processing, data processing, acoustic data processing, statistics and probability, and other modeling and processing arts.

The apparatus may be integrated with systems for controlling alarms and machinery and provides graphical displays that make the operations and status of machinery evident to operators and others monitoring the machinery. It may pass information to other control and communication systems including supervisory control and data acquisition (SCADA) systems or programmable logic controllers.

The apparatus incorporates data analysis, display, connectivity with monitoring systems, pattern comparison and recognition, data compression and storage methods, analysis and filtering in the time frequency domains, and other information and signal processing methods that would be readily apparent to one skilled in the art. Other technical features may be readily apparent to one skilled in the art from the following figures, descriptions, and claims.

This invention combines the utility of monitoring and distributed monitoring of machinery with the unique capabilities of optical fibers as distributed transducers, and creates new benefits that emerge for systems with related elements, such as conveyor systems. One advantages of this combination is the ability to monitor hundreds or thousands of locations that may be spread over a large distance with a single system. Using conventional electrical detection and communication methods can become cumbersome at this scale.

Another advantage is that by monitoring parameters at many related points spanning large distances, it becomes possible to visualize and analyze how the signal varies over distance along machinery as well as through time. This allows for new ways of signal processing, analysis, and display or playback methods that reveal how vibrations change along the equipment and through time. This can both increase sensitivity and reduce the occurrences of false negative or false positive findings from condition monitoring. It can also provide more information regarding machine operation, for example the visualization of changing conditions that move along the machine, such as a new payload moving down a conveyor, versus signals persistently associated with fixed locations, such as vibration of a failing bearing.

One means for enhancing this monitoring would be modifications to the belt designed to make distinctive vibrations, so that the position and speed of the belt may be monitored. It may also involve, for example, changing thresholds and estimated trends as a function of how the signal varies along the machinery. This can be used for enhanced performance and efficiency. For example, data associated with a belt defect or pay load may be monitored efficiently and compactly even with changing amplitude or power of signals along the conveyor.

Another advantage is that optical fibers may monitor multiple parameters, for example monitoring vibration and temperatures of bearings or motors and strain in supporting elements. Another advantage is that optical fibers do not require electrical signals, so they can be used in environments in which sparks and electrical power could pose hazards.

The device that provides light and receives and processes signals returning back from one or more optical fibers may be attached to one end or both ends of an optical fiber cable or to multiple optical fiber cables or loops. Loop configurations can offer advantages in terms of calibration of signals and compensation for attenuation or changes along the fiber. The device may expose portions of the cable to known conditions in order to facilitate calibration and performance testing. Examples could include known temperature baths and known vibration regimes.

The optical fiber may be built into a durable cable that includes elements to protect the optical fiber, to increase the strength and durability of the cable, to create heat pulses in the cable for enhanced sensing capabilities, to conduct electrical signals, to enhance or facilitate coupling the cable to devices, or other improvements that increase the practicality and efficiency of the system. The device provides the pulses sent down the cable and also records parameters of the backscattered light to reveal the vibrations occurring at many locations along the cable. Such parameters can include, for example, the time of arrival, frequency, and the phase of returning backscattered light. The values of these parameters generally include stochastic effects and noise, so the analysis will be typically designed to filter and work with statistical distributions and ranges of values. The device may also analyze data for other parameters of interest, such as temperature or strain along the cable. It will be understood that in other embodiments, fewer sensors may be used, or additional sensors may be included. It will be understood that communication of electronic signals may be accomplished with wires or wireless systems.

The device that provides and receives light and processes the signal may be detachably coupled to an optical fiber cable so that it may be used to interrogate multiple cables that may be installed in various places. It may also remain in one place but be able to be attached or coupled to multiple cables that are monitored in parallel or sequentially. Sequential and parallel monitoring may be accomplished in various ways, including optically (e.g., splitters, rotating prisms or minors, and other means), electrically within the device, or using software. In these ways, a relatively expensive device may be used to monitor multiple cables.

Various embodiments will require varying amounts of signal and data processing, storage, and various input and output devices. These capabilities may be built into a single unit and/or distributed among multiple systems that are linked in a variety of ways. For example the main device may have wireless, electrical, or optical fiber links to other computers, data processors, data storage systems, and input and output devices. Either specialized programming and information processors may be utilized or more general-purposed programmable systems.

The optical fiber cable may be selected and packaged to best suit the application, and it may be part of a cable that has other strands, fibers, and materials to achieve desired properties and functions. For example the cable may include metal strands, composites, polymers, electrical conductors, other types of fibers, protective tubes and jackets, and so on. It may also include multiple glass fibers, either single-mode or multi-mode, and possibly with different properties such as index of refraction, etching, or coatings. Properties of interest may include, for example, impedance matching for sensitivity to vibrations of interest, strength, resistance to damage, heat tolerance, suitability for other sensing, visibility, ease of handling and attachment, weight, and cost.

There can also be devices attached to the cable at various points that provide intentional vibration or other types of inputs as a means for conveying and storing markers or information regarding the operation, calibration, or state of the machinery. For example, one or repeating tones or clicks might be generated at a particular location to signify a change in operations, such as the opening or closing of a chute or to indicate a speed. There also may be other data gathering and transmission means to collect other operational data from the machinery to enhance or assist with the use of the data collected through the optical fiber. For example, there may be remotely located temperature or force measurement devices located on machinery that do not utilize the optical fiber system but provide additional data for the calibration, processing, and monitoring.

The length and details of the cable can affect the frequencies that may be monitored and the spatial resolution that can be achieved, but embodiments may record a wide range of frequencies and record and analyze data with varying spatial resolution to suit the application.

It is known in the art that there are a variety of ways to play back and/or display data. Data may be played back and/or displayed using a variety of transform methods, such as heterodyning, to convert ultrasounds that are picked up and recorded by the instrument into the audible range. This allows users to hear and recognize sound patterns through headphones or speakers. A wide variety of transforms and algorithms may be used to filter, amplify, modify, and enhance the output of data and of analysis results. A variety of graphic displays of data may also be helpful, including amplitude and power spectrums, displays of how maximum amplitudes and/or powers are changing at various frequencies, spectrograms, animations showing changes over time, and other methods commonly used to visualize acoustic, vibration, and video data. Of particular interest for conveyor systems, displays can present either or both of the findings at specific locations (e.g., bearing sounds and trends for each roller) and images that follow the pay-loads and/or continuous elements (such as belts or chains) as they move along the system. Means for effectively communicating data and results are known to those with expertise in these arts.

Embodiments of the invention may collect continuous data that may be analyzed and displayed or played in real-time, and may also store raw and processed data for future analytical, graphical, or audio play-back methods.

The large quantity of data collected by such a system presents challenges. For example, if a 16-bit quantization of vibration is recorded at 100 kHz at each of 1,000 locations, then even without additional storage for error correction or related data to be stored, the device will produce 200 megabytes of data per second. However, a variety of means are known in the art for the handling and compression of acoustic, image, and other large data streams. For example, there are a variety of data compression algorithms; high-capacity and throughput data analysis and storage systems; spectrum analysis and frequency-domain based compression and presentation; algorithms, presentation and playback methods that focus on detecting and tracking changes though time that reduce need to store data; selective sampling and storage methods; and other means developed for handling large quantities of vibration and visual data. A variety of methods are also known in the art for identifying, amplifying, and emphasizing signals of interest, and these may also find use in embodiments. Methods are also known for efficient processing of such data streams, for example the use of multiple parallel processors, the use of graphics processing units (GPUs), and using networks including multiple computers. Methods previously developed for analyzing how vibration signals may relate to machinery condition may also be incorporated. For conveyor systems, some compression and analysis methods may be used that focus data storage and display on vibrations that move along the system. This may both reduce storage needs and increase the utility of displayed information.

Some of the methods and algorithms may dynamically control how much and what data is stored and processed depending on characteristics of the signal. Examples would be to reduce sampling and/or storage during periods of little change and to increase sampling and/or data storage when there are indications that the data may be of greater interest. Ways to adjust the data rate and temporal resolution include changing the sample window duration and/or the frequencies being monitored when spectrums are calculated using Fourier transforms. Other compression methods also include parameters that increase or decrease the degree of compression and the type and amount of information that is lost. Indicators for when sampling or data storage should be varied could include analyses of spectrums, comparisons of signal amplitudes and/or power to thresholds or rates of change, and other algorithms designed to identify when sampling or storage should be modified.

Filtering may also be used to reduce the data storage needs and assist with analyzing, interpreting, and presenting or playing back the data. For example, in order to store information about low frequencies a low-pass filter could be used to reduce the high frequency information that is collected.

A variety of output devices and means may be used to allow making the best use of the data and results of analysis. For example, graphics on displays and computer screens, indicator lights, audible alarms or signals, and other means may be used. These output signals may be transmitted wirelessly, through wires, through optical fibers to remotely located devices that detect such signals and provide output, or through other means so that the location of the output is of greatest utility. The output may also be used to actuate machinery and affect changes in operations. For example, signals that indicate a failing component may turn off certain machinery or adjust machinery or processes.

This monitoring system may be built into the machinery or retrofitted. It may be integrated with other monitoring, communication, and control systems or implemented as a stand-alone system.

This disclosure is not limited to use with conveyor belt systems, or for conveyor belt systems of particular sizes, designs or intended function. It may be used with any machinery with a plurality of related or similar components so that comparisons and analysis utilizing changes and similarities among those components enhances the ability to recognize changes or signals of interest. Another example of an application would be a pipeline, for which segments are analogous to repeated machine elements, and so for example a large object moving down the pipe may be recognized by monitoring vibration at multiple locations and comparing signals. Other examples include machines with many rollers, such as material handling machines used in paper and fabric manufacturing and printing.

The above description and its associated figures have described and illustrated various aspects of particular implementations of the monitoring system. Other embodiments could be used without departing from the scope of this disclosure.

In some embodiments, various functions described above are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of media.

It may be advantageous to set forth definitions of certain words and phrases used throughout this patent document. The term “couple” refers to a direct or indirect communication between two or more elements, whether or not those elements are in physical contact with one another. The terms “application” and “program” refer to one or more computer programs, software components, sets of instructions, procedures, functions, objects, classes, instances, related data, or a portion thereof adapted for implementation in a suitable computer code (including source code, object code, or executable code). The terms “transmit,” “receive,” and “communicate,” as well as derivatives thereof, encompass both direct and indirect communication, whether wireless, through wires, through optical fibers, or via other means. The terms “include” and “comprise,” as well as derivatives thereof, mean inclusion without limitation. The term or is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. The term “controller” means any device, system, or part thereof that controls at least one operation. A controller may be implemented in hardware, firmware, software, or some combination of at least two of the same. The functionality associated with any particular controller may be centralized or distributed, whether locally or remotely. The terms “machine elements” and “machine components” mean any parts of machinery, including both moving and fixed parts, and including supports and ancillary parts in addition to the core hardware comprising a machine.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the claims.

1. A monitoring system comprising:
a fiber optic cable disposed relative to a distributed system to be monitored such that the fiber optic cable is proximate to, and responsive to conditions occurring at, multiple different locations in the distributed system;
a computing system operative to receive and store signals from the fiber optic cable, the computing system including a data-holding subsystem containing instructions executable by a processor to:
ascertain that signals received from the fiber optic cable correspond to conditions that have arisen at two or more distinct and identifiable locations in the system to be monitored; and
process the signals corresponding to the conditions at the two or more distinct and identifiable locations so as to yield an output that describes a state or condition of the distributed system.

2. The monitoring system of claim 1, wherein said processing performed via execution of the instructions averages signals from multiple locations, then subtracts said averaged signal from multiple locations, wherein residual elements of signals remaining after said subtraction correspond to differences at locations from the averaged signal.

3. The monitoring system of claim 2, wherein said residual element of signal for a defined period of time is subtracted from the signal at a distinct location for a second defined period of time, utilizing an offset between said two defined time periods equal to the time between events that may similarly change signals being generated at said two distinct locations.

4. The monitoring system of claim 1, wherein frequency spectra are calculated from the signals at each of the two or more distinct locations, such spectra being compared with spectra at other locations expected to have similar signals, to thereby identify locations with anomalous and changing vibration.

5. The monitoring system of claim 3, wherein the frequency spectra are binned or discretized to create spectral histograms.

6. The monitoring system of claim 1, wherein said multiple locations correspond to multiple components of a machine.

7. The monitoring system of claim 6, wherein the machine has a plurality of similar components expected to produce similar vibration and temperature signals when operating under similar conditions.

8. The monitoring system of claim 6, wherein the machine is a conveyor machine including a plurality of similar components.

9. The monitoring system of claim 1, wherein the fiber optic is incorporated into a cable reinforced or protected by metals and/or polymers.

10. The monitoring system of claim 1, wherein more than one fiber optic is used.

11. The monitoring system of claim 1, wherein said processing performed via execution of the instructions includes shifting the frequencies of signals.

12. The monitoring system of claim 1, wherein the fiber optic cable is tightly mechanically coupled to the distributed system.

13. The monitoring system of claim 1, including a vibration-reducer to prevent vibrations at one location from being transmitted to adjacent locations via the fiber optic cable.

14. The monitoring system of claim 1, wherein the fiber optics is looped or wrapped at locations to be monitored in order to deploy a greater length of fiber optic sensing cable near a location.

15. The monitoring system of claim 1, wherein said condition monitored includes temperature.

16. The monitoring system of claim 15, wherein temperature at one of said multiple locations is compared with a threshold temperature, said threshold temperature exceeding the mean temperature existing at distinct said multiple locations corresponding to similar elements of said distributed system.

17. The monitoring system of claim 1, wherein said condition monitored includes vibration.

18. The monitoring system of claim 17, wherein vibration at one of said multiple locations is compared with a threshold vibration, said threshold vibration exceeding the mean vibration existing at distinct said multiple locations corresponding to similar elements of said distributed system.

19. The monitoring system of claim 1, wherein said condition monitored include strain.

20. The monitoring system of claim 6, wherein the machine being monitored incorporates mechanisms for generating signals that can be detected by the monitoring system.
